(19) United States
(12) Patent Application Publication
(10) Pub. No.: US 2007/0286368 A1
(43) Pub. Date: Dec. 13, 2007

(54) SYSTEM AND METHOD FOR CALL ROUTING DEVICE THAT GENERATES CALLS THROUGH A COMPANY'S TELECOM INFRASTRUCTURE

(76) Inventor: Reuven Gamliel, Afula (IL)

Correspondence Address: JAECKLE FLEISCHMANN & MUGEL, LLP, 190 Linden Oaks, ROCHESTER, NY, 14625-2812, US

(21) Appl. No.: 11/692,328

(22) Filed: Mar. 28, 2007

Related U.S. Application Data
(60) Provisional application No. 60/744,462, filed on Apr. 7, 2006.

(51) Int. Cl. H04M 15/00

(52) U.S. Cl. 379/114.21; 379/114.24; 379/201.01

(57) ABSTRACT

A routing device and method for connecting a free-of-charge call from a customer to a company using the company's own preexisting telecom infrastructure such that the company avoids the added cost of a third party free-of-charge service provider. The device and method provide one or more triggers allowing a customer to initiate a free-of-charge call to the company, e.g., an icon or other link appearing in the company's website or email which a customer may click to initiate the trigger, or an advertised SMS target number to which a customer may send an SMS message. Upon receiving a trigger, the routing device immediately calls the customer back and connects the customer to the appropriate company department or representative.

### RELATED APPLICATION

This application claims the benefit of prior U.S. Provisional Application Ser. No. 60/744,462 filed on Apr. 7, 2006.

### TECHNICAL FIELD

The present invention relates to the routing and connection of incoming calls to a business.

### BACKGROUND OF THE INVENTION

It has become quite common worldwide for companies to carry the cost of incoming telecommunication with potential or existing customers/subscribers. This use of free-of-charge telecommunication service (also commonly referred to as “inbound toll-free” or “1-800” service) enables customers to contact companies at no charge to the customer, a fact that brings many more customers in contact with a company for new purchases and better support service.

The most common free-of-charge phone service is by a published 1-800 number. A block diagram of a 1-800 service is shown in FIG. 1. This method of free-of-charge telephony service has been implemented all over the world. Most of the companies having 1-800 service publish their 1-800 numbers for the use by any customer around the globe.

A company rents this service from one of the 1-800 service providers for the convenience of the company's existing and potential customers. The company publishes its 1-800 numbers, using directories and yellow pages, and also prepares the appropriate infrastructure to receive these calls when customers use the 1-800 numbers to communicate with the company. A company will usually either allocate a separate 1-800 number to each of its service departments, or put an IVR system in place to route the incoming free-of-charge calls to the requested department.

The 1-800 service is usually not an inexpensive service. It is a post pay service that has an unexpected cost nature because the company cannot estimate in advance what will be the extent of usage of the 1-800 numbers.

Lately, as the internet has become a common method for customers to look for companies' services and goods, a new free-of-charge contact service was introduced by internet providers. A block diagram of an internet-enabled service is shown in FIG. 2. The internet-based external free-of-charge service providers enable the initiation of the free-of-charge call from the company web site as a part of the service they provide. This call can be a simple phone call (or a VoIP type of call) generated from the internet-based external free-of-charge service provider's switch to make one connection to the customer and a second connection to the company.

After a pre-registration for this service, the company receives an icon that is presented in the company's web site. When the customer wants to communicate with the company, he or she clicks this icon. At this instant, two phone calls are generated by the internet-based external free-of-charge service provider's servers: one call to the customer, and the other to the company. The internet-based external free-of-charge internet-based external free-of-charge service provider charges the company a certain fee for each such connection. Then, the cost of these two calls is also paid by the company to their telecom service provider. It therefore may be very expensive according to the distance from the internet-based external free-of-charge service providers' server location to the company's location and to the customer's location. For example, the icon in the web site of a company located in NY may be served by an internet provider located in Dallas. When a customer located in Alaska uses the Icon service, there will be one call from Dallas to Alaska, and a second call from Dallas to NY. The connection of the two expensive calls enables the customer to talk with the company free-of-charge, while the connection costs are covered by the company.

The arrangement of the internet initiated calls is very convenient and serves the need of the companies so that any customer that visits its web site will be able to immediately call the company and make the purchase.

However, both the 1-800 service and the internet initiated call methods are expensive in that their cost is in addition to the cost of the company's already existing telecom infrastructure (e.g., a PBX service, VoIP lines, VPN arrangements, Telular—cellular adapters, low price agreements with local, national and/or international telecom carriers, etc.) A Company has thus already invested a one-time cost to build a cost-effective communication infrastructure solution that will serve its employees and customers while significantly saving telecommunication costs. The company that has spent a lot to build a cost saving and efficient communication system must therefore spend even more to enable free-of-charge calls for its customers, a service that is supported by a third-party infrastructure such as the operators' and providers' systems.

In addition to the above expense of the existing internet-based call back system, the fact remains that this internet-based call back system is only available to internet users. It does not serve those customers who, at the moment they wish to contact the company, do not have internet access and are thus unable to initiate a free-of-charge call to the company. This is yet another serious drawback to the present internet-based call back system.

There is thus a need for a solution that will use the company's own cost effective communication infrastructure to service free-of-charge calls initiated by a customer and thereby substantially or entirely avoid the connection costs which would otherwise be incurred with an 800 service or internet provider. There is also a need for a free-of-charge telecom service which uses a company's telecom system and is available to all customers through a variety of company advertising and call triggering methods.

### SUMMARY OF THE INVENTION

The present invention addresses the above need by providing a method by which customer's may initiate a free-of-charge telecom service which uses the company's own existing or newly acquired telecom infrastructure, thus avoiding the significant added costs associated with the use of free-of-charge service providers.

In a first aspect, the invention provides a call routing device connected to the company's preexisting or newly acquired telecom infrastructure. The call routing device is operable to receive a substantially free-of-charge call (or “trigger”) from a customer and immediately return a call to the customer using the company's own preexisting or newly acquired telecom infrastructure. This is extremely cost effective for the company in that no third party telecom provider is required to connect the customer free-of-charge to the company.

It is noted that the term “free-of-charge” is not intended to mean the customer could never incur a third party connection cost to place a trigger to the company. It is thus to be understood that in some cases, a customer may incur a minimal third party charge to place the trigger call to the company. For example, the customer may incur a very brief connection charge from their own service provider when placing a trigger call to the call routing device. Even with this minimal charge, the customer and company using the present invention still benefit from the significant cost savings of not having to pay any third party costs for the customer service call which immediately follows the trigger call from the customer, i.e., the call which connects the customer to the company representative.

A free-of-charge trigger may be initiated the customer in at least one but preferably a variety of different ways. For example, a trigger may be initiated by the customer clicking on a free-of-charge icon or other link appearing in the company's website or in an email sent by the company to the customer. Another trigger may be the customer sending an SMS message to an SMS number published in any media by the company. The SMS number may further include a code which is identified with a particular company department or representative. Yet another trigger may be the customer dialing a published number with caller ID service identifying the customer's phone number. The customer hangs up prior to incurring a connection charge (or only incurs a very minimal charge) and the routing device immediately calls the customer back using the caller ID feature. In the preferred embodiment, the routing device connects the customer to a predetermined representative's extension. It is also possible that the customer may be instructed to call a published number, let the system answer, dial a service code and then hang up. The routing device is programmed and operates to cause the company to call the customer back (identified by the caller-ID service) and connect the customer to the appropriate company department or representative (according to the code entered).

It will be appreciated that regardless of which trigger is used, the invention provides a method by which the customer may initiate and connect a free-of-charge call with the company. Both the company and customer benefit by (1) immediately connecting the customer with the desired department or representative which provides superior service to the customer in that they are not put on hold nor do they need to be transferred between departments and representatives, and (2) by the company not incurring the added cost of a third party free-of-charge service provider, and thereby being able to pass these cost savings on to the customer through lower prices, for example.

### BRIEF DESCRIPTION OF THE DRAWINGS

FIG. 1 is a block diagram of a prior art 1-800 service;

FIG. 2 is a block diagram of a prior art internet-enabled service;

FIG. 3 is a block diagram according to one embodiment of the present invention showing a call routing device connected to a company's communication infrastructure (telephony & data);

FIG. 4 is the system of FIG. 3 with more detail;

FIG. 5 is the routing device of FIGS. 3 and 4 with further device detail;

FIG. 6 is the routing device of FIG. 5 with yet further detail;

FIG. 7 a block diagram of dual phone lines and a connection to the internet through the call routing device where the call routing device remains in the connection path between the customer and the company;

FIG. 8 is a block diagram showing one phone line and one PBX extension line between the customer and the company that has been established by the call routing device;

FIG. 9 is a block diagram showing dual phone lines and dual PBX extension lines between the customer and the company that have been established by the call routing device; and

FIG. 10 is a flow chart showing the basic operating steps of the invention.

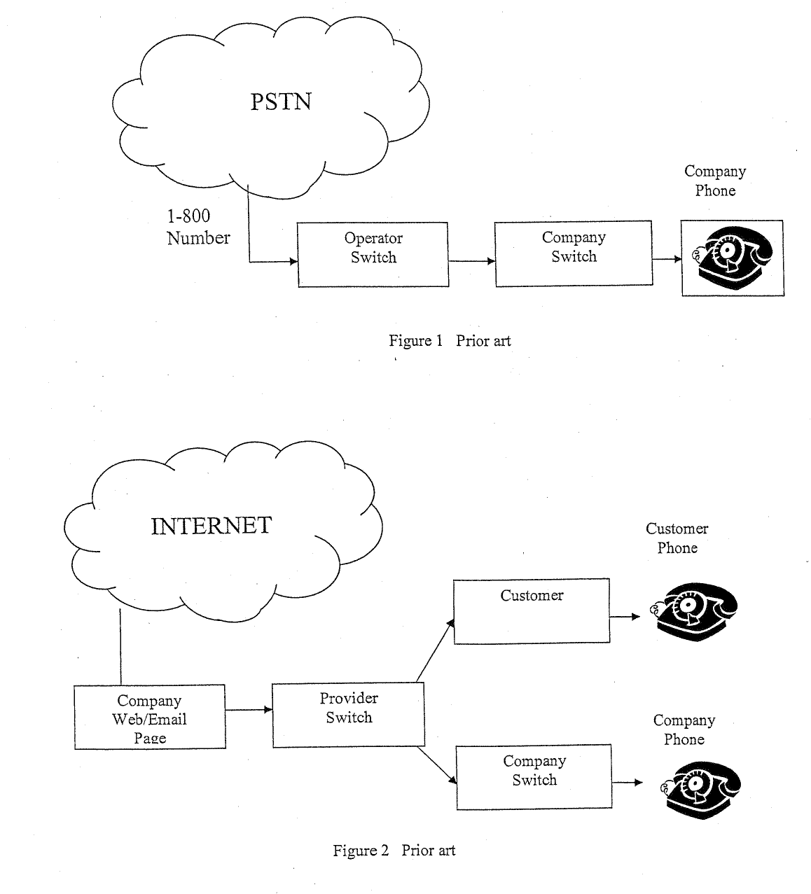

### DESCRIPTION OF THE PREFERRED EMBODIMENTS

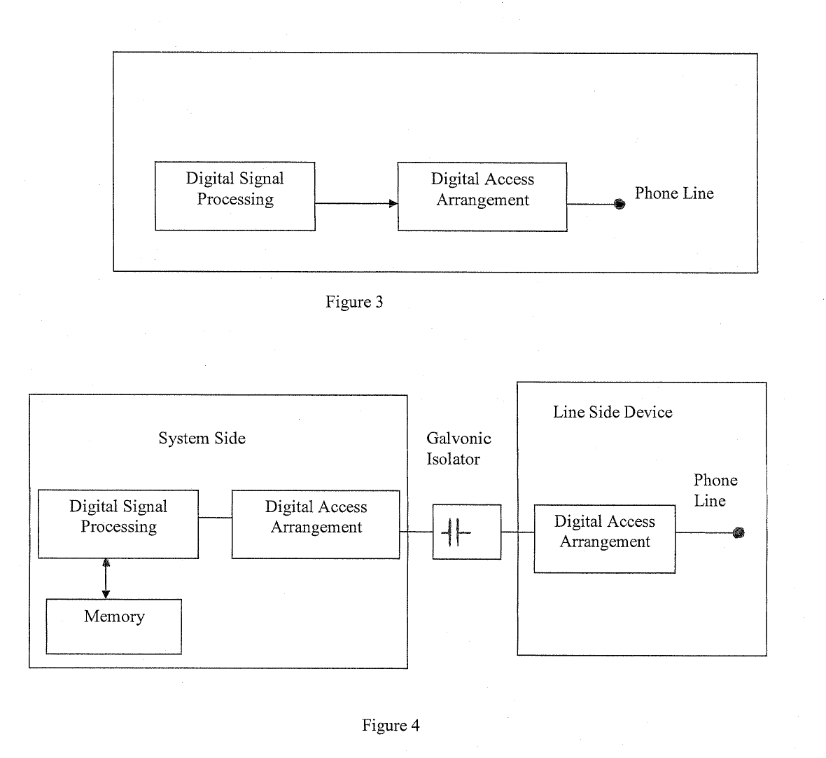

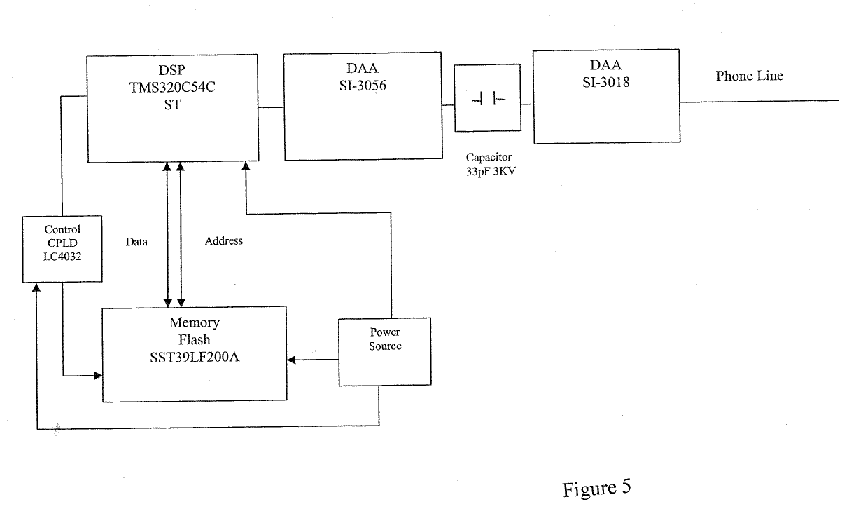

In a first aspect of the inventive system and method, a call routing device according to one embodiment of the present invention is connected to a company's communication infrastructure (telephony & data) as shown generally in the block diagram of FIG. 3, with more detail shown in the block diagram of FIG. 4, and a device block diagram shown in FIG. 5. The call routing device serves the company in various ways to enable the company to use its own preexisting or newly acquired communication system for connecting a free-of-charge call from the customer to the company.

The call routing device software includes three main software components:
1. Operation System Software—software that resides in the DSP shown in FIG. 5 and manages the supervisory operation of the DSP.
2. Application Software—software that implements all the activities and the functions that are described below.
3. Customer's Profile Data Base Software—software that manages the information about the company representatives and the company's potential customer, such as names, PIN codes, dial restrictions, phone numbers, call transfer instructions, and scheduling parameters.

It is of course understood that the above three components may be considered as a single software package. It is also understood that the invention is not to be limited to the particular device design shown in the Figures which illustrate an example of but one possible call routing device which may be programmed to operate according to the teachings of the present invention. It will thus be apparent to one skilled in the art that it would be possible to use other call router device designs having different electronic and/or software components in various design configurations according to the needs and desires of the end-user's system.

In this way the company saves the use of other operators' and internet-based external free-of-charge service provider internet-based external free-of-charge service providers' infrastructure, and uses its own resources to enable a free of charge connection to the company, doing that in an efficient way and with minimum cost. Moreover, the company can control the destination of each free-of-charge incoming call, so that the appropriate company department or representative will get the call and give the best service to the customer.

The company will publish its free-of-charge service on the company WEB site, advertisement boards, newspapers, and in company emails, for example, and will in the same advertisement mention the way that the customer may place a free-of-charge call to the company.

The call routing device is programmed to enable at least one but preferably several ways to trigger the call from the customer to the company, and various possibilities to execute this call, all depending on the company's needs and existing communications infrastructure.

For example, the customer may be able to click an icon button or other link in the company's web site or email, or use his or her mobile or land line phone to send a certain SMS, or to send yet another type of data trigger to the call routing device. There is also a possibility to call a published number and disconnect before answer such that the customer does not incur any or only an very small connection charge. The company may also publish a code for the customer to enter which indicates the desired department or representative the customer wishes to speak to. Upon receiving such a trigger, the call routing device will immediately generate the return call to the customer, using the company's telephony infrastructure, and then connect him or her to the appropriate company department or representative.

More specifically, the method of generating a free-of-charge call from the customer to the company is generally based on the following sequence:
a. The customer looks at the company's advertisement, e.g., the company's web site, a company email, etc., to ascertain the manner by which the customer may place the free-of-charge call to the company.
b. The customer sends a trigger for a free-of-charge call to the company.
c. The call routing device receives the trigger and generates a call back to the customer using the company's local telephony infrastructure, and then connects him to the appropriate company department or representative.

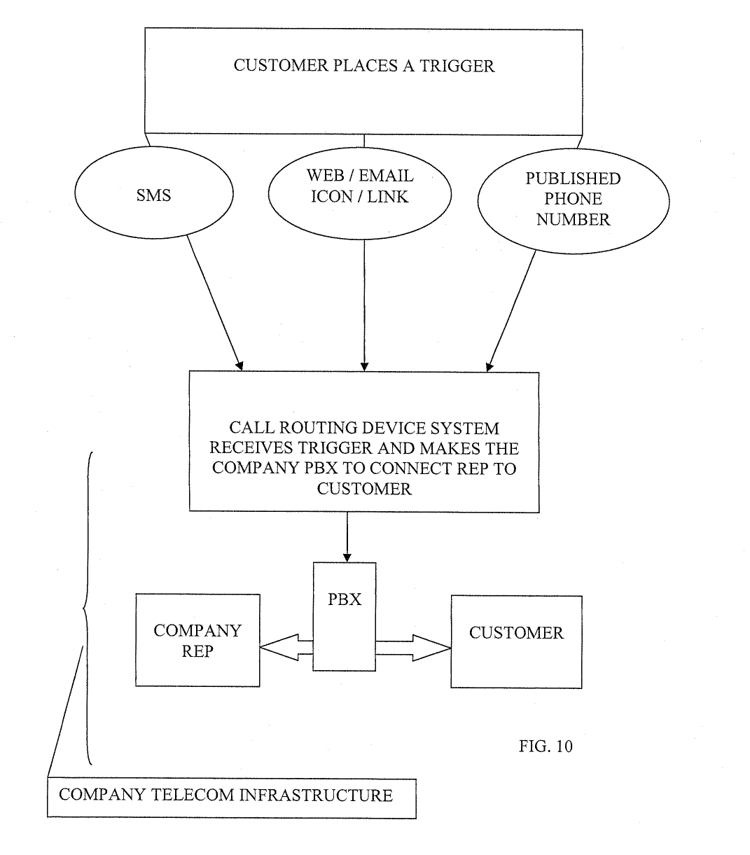

As mentioned above and with reference to the flow chart of FIG. 10, a free-of-charge call from a customer to the call routing device may be triggered in any one of several possible ways:
a. A button icon or other link on the company web site (or in an email or advertisement). Clicking this button will enable the customer to put in his or her phone number and send a data message to the call routing device via its connection to the internet. Optionally, the website may be designed so that clicking the icon or other link creates a pop-up click box including a clicker and advertising media for viewing and/or listening by a customer. A company having acquired the call routing device system of the present invention may therefore have the option of purchasing such additional advertisement options for the pop-up box.
b. An SMS message sent to a certain number that is connected to the call routing device, either directly or through a central server, and will identify the SMS sender's number.
c. A “call and hang up” process in areas where a caller ID is possible. The customer calls a published phone line that is connected to the call routing device and terminates the call prior to incurring a connection charge.

As the call routing device receives the trigger in any of these ways, it identifies the customer's phone number and generates a call to the customer, using the company's telephony infrastructure (to which the device is connected) and then connects the customer to the company's department or representative. The trigger may be sent directly to the call routing device or it may be relayed to the call routing device by a central server that manages many such call routing devices in use by any number of companies.

As stated above, the call routing device is connected to the company's existing or newly acquired communication infrastructure. There are various possibilities to connect it to any type of telecommunication signal relay such as phone lines, PBX extensions, VoP and VoIP lines, wireless and GSM adaptors, for example, or any possible combination of these In any form of connection, the call routing device will also be connected to the internet.

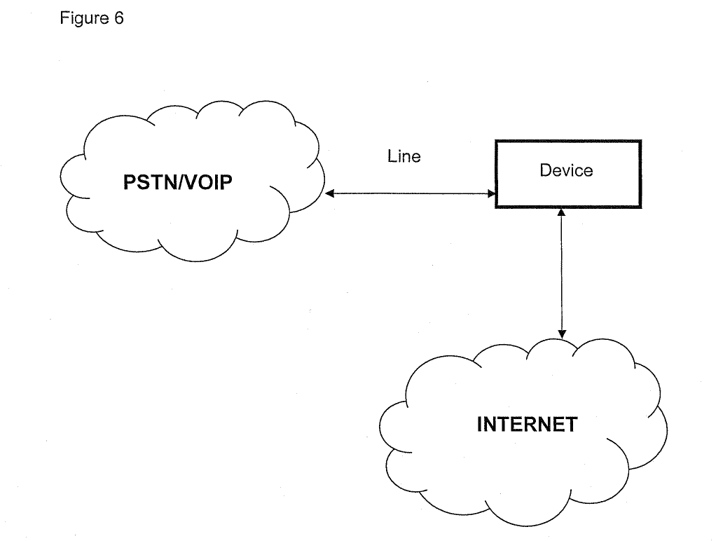

FIG. 6 is a block diagram of a single phone line and a connection to the internet through the call routing device.

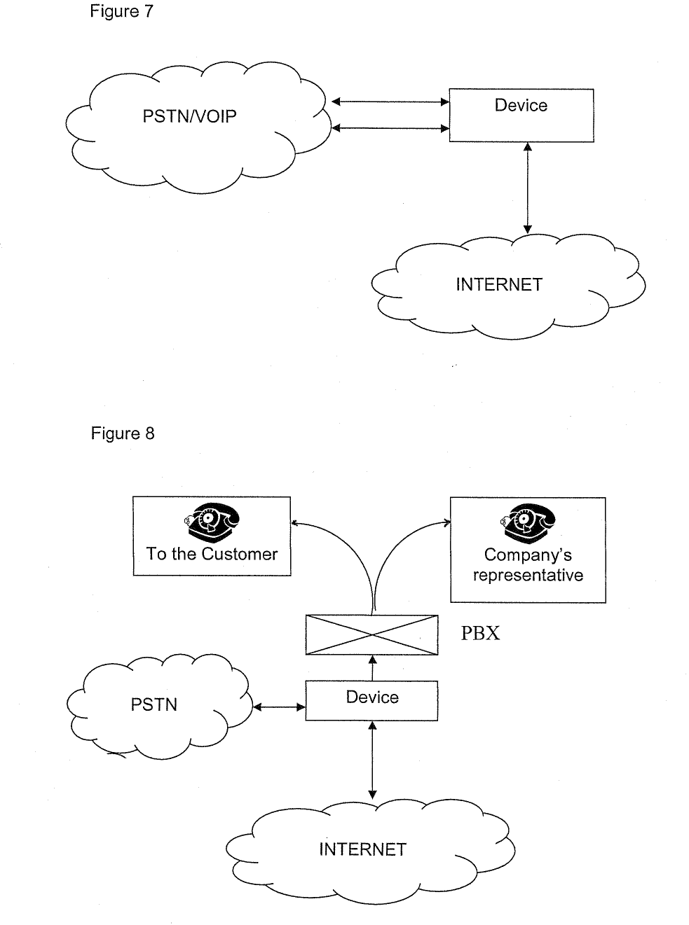

FIG. 7 a block diagram of dual phone lines and a connection to the internet through the call routing device.

In the embodiments shown in FIGS. 6 and 7, the call routing device remains in the connection path between the customer and the company.

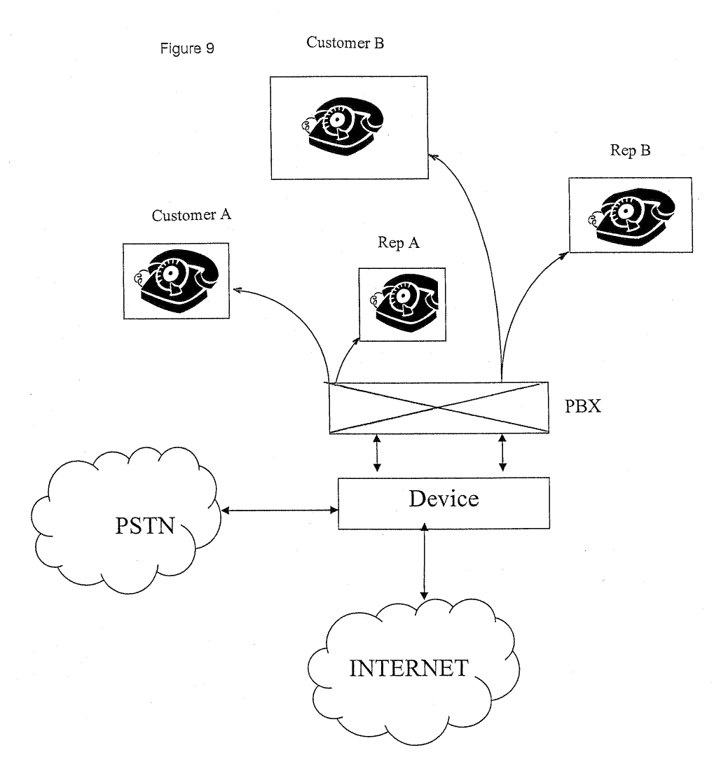

FIG. 8 is a block diagram showing one phone line and one PBX extension line between the customer and the company that has been established by the call routing device.

FIG. 9 is a block diagram showing dual phone lines and dual PBX extension lines between the customer and the company that have been established by the call routing device.

As one of the customer's triggers arrives, the customer's phone number is identified, and the call routing device generates a phone call to the customer and connects him or her to the company department or representative. The call can be executed by methods of dialing on the phone line, or dial from a PBX extension, or call transfer, or conference call, or through a VoIP line or any other type of line connected. Then the call is connected to the company department or representative in a direct/indirect connection to another extension, or call transfer to another phone line or even to a company representative's cell phone (particularly useful if he or she is out of the company).

In yet further possible embodiments of the invention, the routing device is programmed and operable to connect the customer to a preselected telecommunication device of a company representative. The preselected telecommunication device may be selected depending on the day and/or time of the trigger or location of the company representative. For example, a company representative may wish to have a trigger connect to his or her cell phone in the evenings or on weekends, or whenever they are away from the office.

The routing device may also be programmed and operable to connect the customer to a prerecorded message. For example, the customer may be connected to the prerecorded message during non-business hours or whenever there is no company representative available.

The routing device may also be programmed and operable to selectively block predetermined incoming calls. For example, calls originating from a particular origin or previously “black-listed” numbers may be blocked from using the free-of-charge service.

It is also possible to provide remote signal access and processing to the call routing device to allow for remote maintenance and programming thereof as needed or desired by the customer. One example of this type of remote device access is done by today's cable companies who routinely perform remote maintenance and programming of their customer's digital cable boxes.

The embodiments described are to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

What is claimed is:

1. A method for a company having a telecom infrastructure to provide a free-of-charge telecom service for its customers while avoiding the use and associated expenses of an external free-of-charge calls service provider, said method comprising the steps of:
a) providing a routing device connected to the company's telecom infrastructure;
b) providing a method by which a customer may initiate a free-of-charge call trigger to said routing device; and
c) said routing device, upon receiving a trigger, initiating an outgoing telecom signal to the customer through said telecom infrastructure and connecting the customer to a company representative.

2. The method of claim 1 wherein said customer is connected to a specific company representative or department.

3. The method of claim 1 wherein said trigger is an internet signal associated with the customer clicking an icon or other link appearing on the company's website.

4. The method of claim 3 wherein said internet signal is directed to a central server which then directs said internet signal to said routing device.

5. The method of claim 1 wherein said trigger is an internet signal associated with the customer clicking an icon or other link appearing in an email from the company.

6. The method of claim 5 wherein said internet signal is directed to a central server which then directs said internet signal to said routing device.

7. The method of claim 1 wherein said trigger is an SMS signal.

8. The method of claim 7 and further comprising the step of said company advertising a target SMS number.

9. The method of claim 8 and further comprising the step of said company advertising a code by which a customer sending an SMS trigger may connect to a specific company department or representative.

10. The method of claim 7 wherein said SMS signal is directed to a central server which directs the SMS signal to said routing device over the internet.

11. The method of claim 1 wherein said trigger is a phone number advertised by the company and dialed by the customer, said method further comprising the step of:
said routing device identifying the customer's phone number.

12. The method of claim 11 wherein said customer's phone number is identified by a number that has been automatically entered by the customer's telecom device.

13. The method of claim 12 wherein said customer's telecom device is a PC.

14. The method of claim 12 wherein said customer's telecom device is a wireless device.

15. The method of claim 14 wherein said customer's telecom device is a wireless hand-held device

16. The method of claim 11 wherein said customer's phone number is identified through a telecom provider caller ID service.

17. The method of claim 11, said method further comprising the step of:
the customer hanging up the phone prior to the customer incurring a substantial connection charge.

18. The method of claim 11, the method further comprising the step of:
said customer entering a code the call routing device is programmed to identify as the company department or representative the customer wishes to speak to.

19. The method of claim 1 wherein said routing device receives the trigger via a central server of a service provider.

20. The method of claim 1 wherein said routing device is operable to connect the customer to a preselected telecommunication device of a company representative.

21. The method of claim 20 wherein the preselected telecommunication device is selected depending on the day and/or time of the trigger.

22. The method of claim 1 wherein said routing device is operable to connect the customer to a prerecorded message.

23. The method of claim 22 wherein the customer is connected to the prerecorded message when there is no company representative available.

24. The method of claim 1 wherein said routing device is operable to selectively block predetermined incoming calls.

25. The method of claim 3 wherein clicking said icon or other link creates a pop-up click box including a clicker and advertising media for viewing and/or listening by a customer.

26. A system for a company having a telecom infrastructure to provide a free-of-charge telecom service for its customers while avoiding the use and associated expenses of an external ‘free-of-charge’ calls service provider, said system comprising:
a) a routing device connected to the company's telecom infrastructure; and
b) a trigger by which a customer may initiate a free-of-charge call to said routing device;
whereby said routing device is programmed such that, upon receiving a trigger, said routing device initiates an outgoing telecom signal to the customer through said telecom infrastructure and connects the customer to a company department or representative.

27. The system of claim 26 wherein said routing device is programmed to connect the customer to a specific company representative or department.

28. The system of claim 26 wherein said trigger is an internet signal associated with the customer clicking an icon or other link appearing on the company's website.

29. The system of claim 28 wherein said internet signal is directed to a central server which then directs said internet signal to said routing device.

30. The system of claim 26 wherein said trigger is an internet signal associated with the customer clicking an icon or other link appearing in an email from the company.

31. The system of claim 30 wherein said internet signal is directed to a central server which then directs said internet signal to said routing device.

32. The system of claim 26 wherein said trigger is an SMS signal.

33. The system of claim 32 and further comprising the step of said company advertising a target SMS number.

34. The system of claim 33 and further comprising the step of said company advertising a code by which a customer sending an SMS trigger may connect to a specific company department or representative.

35. The system of claim 32 wherein said SMS signal is directed to a central server which directs the SMS signal to said routing device over the internet.

36. The system of claim 26 wherein said trigger is a phone number dialed by the customer, said system further comprising programming said routing device to identify the customer's phone number.

37. The system of claim 36 wherein said customer's phone number is identified by a number that has been automatically entered by the customer's telecom device.

38. The system of claim 37 wherein said customer's telecom device is a PC.

39. The system of claim 37 wherein said customer's telecom device is a wireless device.

40. The system of claim 39 wherein said customer's telecom device is a wireless hand-held device.

41. The system of claim 36 wherein said customer's phone number is identified through a telecom provider caller ID service.

42. The system of claim 36, wherein the customer hangs up the phone prior to the customer incurring a substantial connection charge.

43. The system of claim 36 wherein said call routing device is programmed to identify a code entered by the customer as the company department or representative the customer wishes to speak to.

44. The system of claim 26 wherein said routing device receives the trigger via a central server of a service provider.

45. The system of claim 26 wherein said routing device is programmed and operable to connect the customer to a preselected telecommunication device of a company representative.

46. The system of claim 45 wherein the preselected telecommunication device is selected depending on the day and/or time of the trigger.

47. The system of claim 26 wherein said routing device is programmed and operable to connect the customer to a prerecorded message.

48. The system of claim 47 wherein the customer is connected to the prerecorded message when there is no company representative available.

49. The system of claim 26 wherein said routing device is operable to selectively block predetermined incoming calls.

50. The system of claim 28 wherein clicking said icon or other link creates a pop-up click box including a clicker and advertising media for viewing and/or listening by a customer.

51. A call routing device for installation with a company's preexisting or newly acquired telecom infrastructure, said call routing device operable to initiate an outgoing call from a company department or representative to a customer in response to receiving a trigger sent to the call routing device by the customer.

52. The call routing device of claim 51, wherein said trigger is selected from one of the following triggers:
a. sending an SMS published by the company;
b. clicking an icon or other link appearing on the company's website or email;
c. dialing a phone number published by the company.

53. The call routing device of claim 51, wherein said routing device is remotely programmable.
